(19) United States
(12) Patent Application Publication
(10) Pub. No.: US 2019/0012693 A1
(43) Pub. Date: Jan. 10, 2019

(54) METHOD FOR SELLING NO-SHOW ITEM AT SPECIAL PRICE AND APPARATUS THEREFOR

(71) Applicant: SK PLANET CO., LTD, Seongnam-si (KR)

(72) Inventor: Young-Chul KIM, Seoul (KR)

(73) Assignee: SK PLANET CO., LTD

(21) Appl. No.: 16/023,380

(22) Filed: Jun. 29, 2018

(30) Foreign Application Priority Data
Jul. 6, 2017 (KR) 10-2017-0086168

(51) Int. Cl. G06Q 30/02

(52) U.S. Cl. CPC G06Q 30/0235; G06Q 30/0264; G06Q 30/0255; G06Q 30/0259

(57) ABSTRACT

Disclosed herein are a method for selling a no-show item at a special price and an apparatus therefor. A no-show item may be sold through processes of acquiring information about the item from a store at which the no-show has occurred, among multiple stores registered in an application, creating promotion information for selling the item at a special price using the information about the item, extracting a promotion target group to which the promotion information is provided in consideration of at least one of the location of the store at which the no-show has occurred, the information about the item, and user information, and providing the promotion information to the promotion target group based on the application. Accordingly, the loss suffered by stores at which no-shows occur may be reduced.

### CROSS REFERENCE TO RELATED APPLICATION

This application claims the benefit of Korean Patent Application No. 10-2017-0086168, filed Jul. 6, 2017, which is hereby incorporated by reference in its entirety into this application.

### BACKGROUND OF THE INVENTION

### 1. Technical Field

The present invention relates generally to technology for selling a no-show item at a special price, and more particularly to a method and apparatus for selling a product or service generated due to a no-show at a special price through which information about a special offer may be provided to potential customers who are likely to buy a no-show item and the corresponding product may be sold, whereby a loss incurred by no-shows may be recovered.

### 2. Description of the Related Art

“No-show”, which has recently become a social problem, is a term commonly used in the food service, flight, and hotel industries, and refers to the situation in which a customer who has made a reservation, booking, or appointment does not show up without providing previous notice thereof. No-shows occur frequently in various business fields, such as restaurants, hospitals, and the like.

The biggest reason why no-shows are regarded as a social problem is that no-shows cause serious economic loss. Particularly, when a no-show occurs in small stores, such as restaurants, hair salons, and the like, such small stores cannot sell reserved products or services and miss the opportunity to provide services to other customers who would otherwise have visited their places at the reserved time, so that they encounter difficulty in managing their businesses.

Some stores take a reservation only when a customer pays a certain amount of money in advance as a deposit in order to prevent a no-show. However, considering the opportunity cost thereof, no-shows cause financial loss and a fall in sales of a corresponding store. In connection with this, Korean Patent Application Publication No. 10-2008-0043108 discloses a technology related to “Method and system for reservation of service”.

### SUMMARY OF THE INVENTION

An object of the present invention is to provide a method for reducing the loss of a store incurred by no-shows, which has recently become a social problem.

Another object of the present invention is to provide users of an application with the opportunity to use a no-show item quickly and cheaply.

A further object of the present invention is to make a no-show item appear to potential customers as a cheap and useful one, thereby generating a promotional effect for the corresponding store.

In order to accomplish the above objects, a method for selling a no-show item at a special price according to the present invention includes acquiring information about a no-show item from a store at which the no-show has occurred, among multiple stores registered in an application; creating promotion information for selling the no-show item at a special price using the information about the no-show item; extracting a promotion target group to which the promotion information is to be provided in consideration of at least one of a location of the store at which the no-show has occurred, the information about the no-show item, and user information; and selling the no-show item by providing the promotion target group with the promotion information based on the application.

Here, extracting the promotion target group may include retrieving a group of promotion target candidates, who are located within a preset promotion range based on the location of the store at which the no-show has occurred, from multiple users registered in the application; and selecting a user having a purchase probability that is equal to or higher than a preset percentage from the group of the promotion target candidates and including the selected user in the promotion target group, the purchase probability being calculated based on the user information and the information about the no-show item.

Here, the purchase probability may be calculated in consideration of a list of purchased products included in a category of the information about the no-show item in a list of purchases corresponding to the user information.

Here, creating the promotion information may be configured to set a discount rate to be applied to the no-show item higher as a rate of no-shows in each of the multiple stores is higher.

Here, creating the promotion information may be configured to set the discount rate in consideration of a recommended discount rate and the rate of no-shows when the recommended discount rate set by the store at which the no-show has occurred is present.

Here, selling the no-show item may include changing the discount rate in the promotion information and providing the promotion information including the changed discount rate to the promotion target group when the no-show item has not been sold for a preset sales period from a time at which the promotion information was provided.

Here, retrieving the group of the promotion target candidates may include, when a number of promotion target candidates is less than a preset minimum number of candidates, extending the preset promotion range and retrieving the group of the promotion target candidates again.

Here, selling the no-show item may be configured to provide a sale completion message to remaining users in the promotion target group, excluding a user who bought the no-show item, when the no-show item has been sold.

Also, a server according to the present invention includes memory for storing user information about multiple users registered in an application and information about a no-show item acquired from a store at which the no-show has occurred, among multiple stores registered in the application; and a processor for creating promotion information for selling the no-show item at a special price using the information about the no-show item, providing the promotion information to a promotion target group, which is extracted from the multiple users in consideration of at least one of a location of the store at which the no-show has occurred, the information about the no-show item, and the user information, and thereby selling the no-show item.

Here, the processor may be configured to retrieve a group of promotion target candidates who are located within a preset promotion range based on the location of the store at which the no-show has occurred from the multiple users; and to select a user having a purchase probability that is equal to or higher than a preset percentage from the group of the promotion target candidates and to include the selected user in the promotion target group, the purchase probability being calculated based on the user information and the information about the no-show item.

Here, the purchase probability may be calculated in consideration of a list of purchased products included in a category of the information about the no-show item in a list of purchases corresponding to the user information.

Here, the processor may set a discount rate to be applied to the no-show item higher as a rate of no-shows in each of the multiple stores is higher.

Here, the processor may set the discount rate in consideration of a recommended discount rate and the rate of no-shows when the recommended discount rate set by the store at which the no-show has occurred is present.

Here, when the no-show item has not been sold for a preset sales period from a time at which the promotion information was provided, the processor may change the discount rate in the promotion information and provide the promotion information including the changed discount rate to the promotion target group.

Here, when a number of promotion target candidates is less than a preset minimum number of candidates, the processor may extend the preset promotion range and retrieve the group of the promotion target candidates again.

Here, when the no-show item has been sold, the processor may provide a sale completion message to remaining users in the promotion target group, excluding a user who bought the no-show item.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows a system for selling a no-show item at a special price according to an embodiment of the present invention;

FIG. 2 is a flowchart that shows a method for selling a no-show item at a special price according to an embodiment of the present invention;

FIG. 3 is a flowchart that shows an example of the process of extracting a promotion target group in the method for selling a no-show item at a special price according to the present invention;

FIG. 4 is a flowchart that shows an example of the process of creating promotion information in the method for selling a no-show item at a special price according to the present invention;

FIG. 5 is a flowchart that shows an example of the process of selling a no-show item in the method for selling a no-show item at a special price according to the present invention;

FIG. 6 is a view that shows an example of promotion information provided to users according to the present invention;

FIG. 7 is a view that shows an example of a sale completion message provided to users according to the present invention; and

FIG. 8 is a block diagram that shows a server for selling a no-show item at a special price according to an embodiment of the present invention.

### DESCRIPTION OF THE PREFERRED EMBODIMENTS

Technical terms used in this specification are used only to describe specific embodiments, and it is to be noted that the terms are not intended to limit the present invention. Furthermore, the technical terms used in this specification should be interpreted as having meanings that are commonly understood by a person having ordinary skill in the art to which the present invention pertains, unless specifically defined otherwise in this specification, and should not be interpreted as having excessively comprehensive meanings or excessively narrow meanings. Furthermore, if the technical terms used in this specification are erroneous technical terms that do not precisely represent the spirit of the present invention, they should be replaced with technical terms that may be correctly understood by a person having ordinary skill in the art. Furthermore, common terms used in the present invention should be interpreted in accordance with the definitions of dictionaries or in accordance with the context thereof, and should not be interpreted as having excessively narrow meanings.

Furthermore, an expression of a singular number used in this specification includes an expression of a plural number unless clearly indicated otherwise by the context. In this application, terms, such as “comprise” and “include”, should not be interpreted as essentially including all of several elements or several steps described in the specification, and should be interpreted as not including some of the elements or steps or as including additional elements or steps.

Furthermore, terms including ordinal numbers, such as “first” and “second” used in this specification, may be used to describe a variety of elements, but the elements should not be limited to the terms. The terms are used to only distinguish one element from another element. For example, a first element may be named a second element, and likewise, a second element may be named a first element without departing from the scope of the present invention.

Hereinafter, preferred embodiments in accordance with the present invention are described in detail with reference to the accompanying drawings. The same or similar elements are assigned the same reference numerals irrespective of reference numerals, and a redundant description thereof is omitted.

In the following description of the present invention, detailed descriptions of known functions and configurations which are deemed to obscure the gist of the present invention will be omitted. The accompanying drawings of the present invention aim to facilitate understanding of the present invention and should not be construed as being limited to the accompanying drawings.

A ‘no-show item’ according to an embodiment of the present invention may mean an available product or service that is not sold and/or consumed due to a no-show.

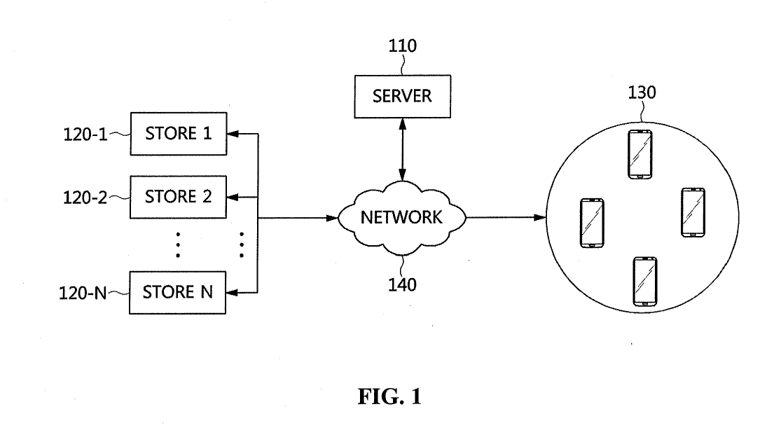

FIG. 1 is a view that shows a system for selling a no-show item at a special price according to an embodiment of the present invention.

Referring to FIG. 1, the system for selling a no-show item at a special price according to an embodiment of the present invention includes a server 110, stores 120-1 to 120-N, multiple users 130, and a network 140.

The server 110 according to an embodiment of the present invention may be a device for selling a no-show item at a special price by communicating with the stores 120-1 to 120-N registered in an application and the multiple users 130 registered in the application based on the network 140. That is, when a no-show has occurred, the server 110 provides the multiple users 130 with promotion information for selling a no-show item at a special price and sells the corresponding item using purchase information input by a user who wants to buy the item, among the multiple users 130.

To this end, the server 110 first acquires information about a no-show item from the store at which the no-show has occurred, among the multiple stores 120-1 to 120-N registered in the application.

Also, the server 110 creates promotion information for selling the no-show item at a special price using the information about the no-show item.

Here, the higher the rate of no-shows in each of the multiple stores 120-1 to 120-N, the higher the discount rate that may be applied to the no-show item.

Here, when there is a recommended discount rate set by the store at which the no-show has occurred, the discount rate may be set in consideration of the recommended discount rate and the rate of no-shows.

Also, the server 110 extracts a promotion target group to which promotion information is to be provided in consideration of at least one of the location of the store at which the no-show has occurred, information about the no-show item, and user information.

Here, a group of promotion target candidates, located within a preset promotion range based on the location of the store at which the no-show has occurred, may be retrieved from the multiple users 130 registered in the application.

Here, when the number of promotion target candidates in the group is less than a preset minimum number of candidates, the promotion target candidates may be retrieved again after extending the preset promotion range.

Here, a user having a purchase probability that is equal to or higher than a preset percentage is selected from the promotion target candidates and included in the promotion target group, the purchase probability being calculated based on the user information and the information about the no-show item.

Here, the purchase probability may be calculated in consideration of a list of purchases included in the category in which the no-show item is included in a purchase list corresponding to the user information.

Also, the server 110 provides the promotion information to the promotion target group based on the application and sells the no-show item.

Here, when the no-show item has not been sold during a preset sales period from the time at which the promotion information is provided, the discount rate in the promotion information may be changed, and the promotion information including the changed discount rate may be provided to the promotion target group.

Here, when the no-show item has been sold, a message announcing the completion of the sale may be sent to remaining users in the promotion target group, excluding the user who bought the corresponding item.

Also, the stores 120-1 to 120-N illustrated in FIG. 1 may be stores registered in the application for selling a no-show item at a special price according to an embodiment of the present invention. Accordingly, when a no-show has occurred at any of the stores 120-1 to 120-N illustrated in FIG. 1, information about a no-show item at the store may be provided to the multiple users 130 using promotion information, and the corresponding item may be sold.

Also, the multiple users 130 illustrated in FIG. 1 may mean user terminals, and may be terminals in which an application for providing a service related to the sale of a no-show item at a special price is installed.

For example, a user terminal is a device on which an application according to the present invention may run by being connected with a communication network, and may be any of various types of terminals including all types of information communication devices, multimedia terminals, Internal Protocol (IP) terminals, and the like, without being limited to mobile communication terminals. Also, the user terminal may be a mobile terminal having various mobile communication specifications, such as a mobile phone, a Portable Multimedia Player (PMP), a Mobile Internet Device (MID), a smartphone, a tablet PC, a laptop, a netbook, a Personal Digital Assistant (PDA), an information communication device, and the like.

Here, user information, the location of a user, and the like may be acquired using the application installed in the user terminal.

For example, the server 110 acquires user information about the multiple users 130 and the locations of the users corresponding to the locations of the user terminals based on the application, and thereby extracts a promotion target group. Here, users included in the promotion target group may check the promotion information related to a no-show item, which is provided to their user terminals, and may buy the item.

Also, the user terminal may receive various kinds of information, such as numbers, letters, and the like, and may deliver signals, input for setting various functions and controlling the functions of the user terminal, to the control unit via the input unit. Also, the input unit of the user terminal may be configured so as to include at least one of a keypad and a touch pad, which generate an input signal in response to the touch or manipulation by a user. Here, the input unit of the user terminal and the display unit thereof may form a single touch panel (or a touch screen), thereby performing both an input function and a display function. Also, the input unit of the user terminal may use all types of input means that may be developed in the future as well as currently existing input devices, such as a keyboard, a keypad, a mouse, a joystick, and the like. Particularly, the input unit of the user terminal according to the present invention may deliver an input signal for buying a no-show item to the control unit of the user terminal.

Also, the display unit of the user terminal may display information about a series of operation states and operation results generated while the function of the user terminal is being performed. Also, the display unit of the user terminal may display the menu of the user terminal and user data input by a user. Here, the display unit of the user terminal may be configured with a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the user terminal is configured in the form of a touch screen, the display unit of the user terminal may perform some or all of the functions of the input unit of the user terminal. Particularly, the display unit of the user terminal according to the present invention may display an interface provided for the purchase of a no-show item and information about execution of the application on a screen.

Also, the storage unit of the user terminal may include a main storage device and an auxiliary storage device as devices for storing data, and may store applications that are necessary for the operation of the user terminal. The storage unit of the user terminal may include a program area and a data area. Here, when the user terminal activates each function in response to a request from a user, the user terminal provides the function by running corresponding applications under the control of the control unit. Particularly, the storage unit of the user terminal according to the present invention may store an Operating System (OS) for booting the user terminal, an application for sending and receiving information input for buying a no-show item, and the like. Also, the storage unit of the user terminal may store information about the user terminal and a content DB for storing multiple pieces of content. Here, the content DB may include execution data for executing content and attribute information about the content, and may store content usage information in response to the execution of the content. Also, the information about the user terminal may include the specifications of the user terminal.

Also, the communication unit of the user terminal may function to send and receive data to and from the server 110 over the network 140. Here, the communication unit of the user terminal may include an RF transmission medium for up-conversion and amplification of the frequency of a sending signal and an RF reception medium for low-noise amplification of a receiving signal and down-conversion of the frequency thereof. Such a communication unit of the user terminal may include a wireless communication module. Also, the wireless communication module is a component for sending or receiving data based on a wireless communication method, and may send and receive data to and from the server 110 using any one of a wireless network communication module, a wireless LAN communication module, and a wireless PAN communication module when the user terminal uses wireless communication. That is, the user terminal may access the network 140 using a wireless communication module, and may send and receive data to and from the server 110 over the network 140. Particularly, the network 140 according to the present invention may send and receive data that are necessary for the purchase of a no-show item by communicating with the server 110 or the user terminal.

Also, the control unit of the user terminal may be a processing device for running an Operating System (OS) and respective components. For example, the control unit may control the overall process of accessing the server 110. When access to the server 110 is made through an application, the control unit may control the overall process of running the application in response to the request by a user, and may perform control so as to send a request for using a service to the server 110 simultaneously with execution of the application. Here, the control unit may perform control such that information about the user terminal required for user authentication is sent along with the request.

The network 140 may provide a channel via which the server 110, the stores 120-1 to 120-N, and the user terminals of the multiple users 130 deliver data therebetween, and may be conceptually understood as including networks that are currently being used and networks that have yet to be developed. For example, the network may be any one of wired and wireless local networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future.

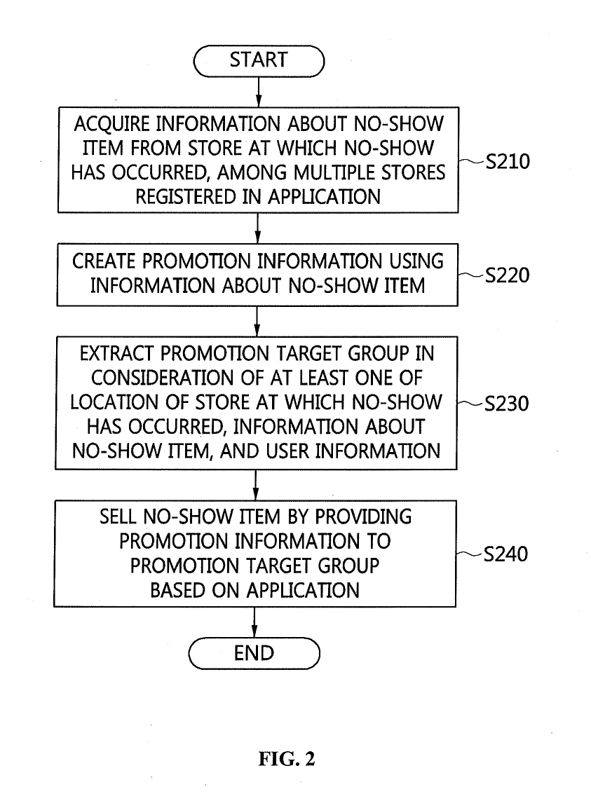

FIG. 2 is a flowchart that shows a method for selling a no-show item at a special price according to an embodiment of the present invention.

Referring to FIG. 2, in the method for selling a no-show item at a special price according to an embodiment of the present invention, information about a no-show item is acquired from the store at which the no-show has occurred, among multiple stores registered in an application, at step S210.

Here, the application may be a program running based on a server for selling a no-show item at a special price, and may be used when a user makes a reservation for a service or product of a store or buys a no-show item. For example, because multiple stores are registered in the application, a user may makes a reservation or buy an item using his or her id registered therein. Here, the details about the reservation or the purchase may be stored as user information.

Here, the store at which a no-show has occurred means the store at which a user that has made a reservation does not show up. Depending on the business type of the store, various kinds of items may be made available due to a no-show. For example, if the store at which a no-show has occurred is a restaurant, a certain dish may be a no-show item. If the store at which a no-show has occurred is a nail art shop, a voucher for nail art or nail care may be a no-show item.

Here, a no-show item, which is to be sold by the store at which the no-show has occurred, may be an item that is difficult to sell after a certain period of time following occurrence of the no-show. For example, a dish that is difficult to serve to a customer when a certain time has passed or a service that can be provided only at the reserved time may be such a no-show item.

Therefore, when a no-show occurs at any of the multiple stores registered in the application, if a no-show item is determined to be difficult to sell after a certain period of time, information about the item is acquired, and the process of selling the item at a special price is performed, but otherwise, the process of selling the item at a special price may not be performed.

Here, information about a no-show item may be received from a PC or a Point-of-Sale (POS) device installed in the store at which the no-show has occurred, and may then be stored in a separate database. For example, when a no-show occurs at restaurant A, a staff member or a manager in restaurant A inputs information about the no-show and information about the no-show item using a terminal or a PC in which the application for a store is installed, thereby providing the information to the server for selling a no-show item at a special price. The information about the no-show and the information about the no-show item, which are provided to the server, may be matched with each other, and may then be stored in the server or in a database that is separate from the server.

Here, the information about the no-show item may include various kinds of information that is necessary in order to sell the item, such as the name of the item, the time at which the item can be used, the price of the item, the store that is selling the item, the location of the store, and the like.

Also, in the method for selling a no-show item at a special price according to an embodiment of the present invention, promotion information for selling the no-show item at a special price is created at step S220.

Here, the promotion information may be an advertising message to be provided to potential customers in order to sell the no-show item. Therefore, the promotion information may include information about the corresponding item to be sold at a special price, the price thereof, the location of the store at which the item can be used, and the like.

Also, if the promotion information is information for advertising the no-show item, the promotion information may include a media file, such as various images, video, and the like, along with the above-mentioned information, and may be created using comments or a design desired by the store selling the no-show item.

Here, the higher the rate of no-shows in each of the multiple stores, the higher the discount rate that may be applied to the no-show item.

For example, the number of times that a no-show has occurred at a certain store during a certain period may be monitored based on information about the occurrence of a no-show or information about a no-show item, which is input from each of the multiple stores, whereby the rate of no-shows may be calculated.

Here, a high rate of no-shows may mean that the sale of a no-show item at a special price is frequently made. That is, there is a high possibility that potential customers use the item of the store having a high rate of no-shows at a low price. Accordingly, in terms of scarcity, the higher the rate of no-shows, the higher the discount rate to be applied to the no-show item may be set in order to increase sales competitiveness, whereby the sales rate of the item may be increased.

Here, when there is a recommended discount rate set by the store at which the no-show has occurred, the discount rate may be set in consideration of the recommended discount rate and the rate of no-shows. That is, in order to minimize the loss arising from the no-show at the store at which the no-show has occurred, it is necessary to sell the corresponding item at a price that is higher than the unit cost thereof. Therefore, when a no-show has occurred, the store at which the no-show has occurred may input a recommended discount rate along with the information about the no-show item so as to be delivered to the server for selling a no-show item at a special price.

For example, when the recommended discount rate input by the store at which a no-show has occurred is 20% and when the discount rate calculated in consideration of the rate of no-shows is 50%, a discount rate of about 35%, which is calculated as a compromise between the two discount rates, may be applied to the no-show item.

Here, the promotion information created for the no-show item may be stored in a separate database after being matched with at least one of the store at which the no-show has occurred and the information about the no-show item.

Also, in the method for selling a no-show item at a special price according to an embodiment of the present invention, a promotion target group to which the promotion information is to be provided is extracted at step S230 in consideration of at least one of the location of the store at which the no-show has occurred, the information about the no-show item, and user information.

Here, the user information may be acquired from a server according to an embodiment of the present invention or a database operating in conjunction with the server. Here, the user information may be information about each of the multiple users registered in the application.

Here, the promotion target group may be a group of users who will receive the promotion information. That is, the promotion target group may be extracted from the multiple users in consideration of at least one of the location of the store at which the no-show has occurred, the information about the no-show item, and the user information.

Here, a group of promotion target candidates, located within a preset promotion range based on the location of the store at which the no-show has occurred, may be retrieved from the multiple users registered in the application. That is, among the multiple users, users who are located within the preset promotion range may be set as a group of promotion target candidates.

Here, information about the locations of the multiple users may be acquired based on the user terminals of the multiple users. For example, the locations of the multiple users may be acquired using a GPS sensor included in each of the user terminals.

Here, the promotion range may be freely set and changed by at least one of the administrator of the server according to an embodiment of the present invention and the store at which the no-show has occurred. However, when the promotion range is set excessively wide, because the amount of data to be processed by the server in order to retrieve a group of promotion target candidates is increased, the promotion range may be set in consideration of the location of the store at which the no-show has occurred.

For example, if the store at which a no-show has occurred is located downtown with a large number of people moving around, many users may be retrieved as promotion target candidates even though the promotion range is set relatively narrow. Accordingly, the promotion range may be set to an area within a 1 km radius around the store at which the no-show has occurred.

In another example, if the store at which a no-show has occurred is located in a sparsely populated region with few people moving around, the promotion range is set relatively wide, whereby more than a certain number of users may be retrieved as the promotion target candidates. In this case, the promotion range may be set to an area within a 10 km radius around the store at which the no-show has occurred.

Here, when the number of promotion target candidates is less than a preset minimum number of candidates, the promotion target candidates may be retrieved again after the promotion range is extended.

For example, when the preset minimum number of candidates is 100 and when the number of promotion target candidates retrieved within a 1 km radius around the store at which a no-show has occurred is less than 100, the promotion target candidates may be retrieved again after the promotion range is extended to a 2 km radius around the store.

Also, when the number of promotion target candidates is less than the preset minimum number of candidates even after retrieving the promotion target candidates again, the preset promotion range may be extended further.

Here, a user having a purchase probability that is equal to or higher than a preset percentage is selected from a group of the promotion target candidates and included in the promotion target group, the purchase probability being calculated based on the user information and the information about the no-show item.

For example, when the preset percentage for the purchase probability is 30%, a user having a purchase probability higher than 30% may be selected from the group of promotion target candidates and may be included in the promotion target group.

Here, it is necessary to provide the promotion information to as many users as possible in order to maximize the likelihood of sale of the no-show item. Accordingly, the promotion target group may be configured so as to include more than a certain number of users. That is, when the promotion information is provided to 50 users, the possibility that the no-show item is sold is increased, compared to when the promotion information is provided only to 10 users.

Therefore, when the number of users included in the promotion target group set depending on the purchase probability is less than a minimum reference number, the preset percentage for the purchase probability may be lowered, whereby the number of users included in the promotion target group may be increased.

Here, the purchase probability may be calculated in consideration of a list of purchases included in the category in which the no-show item is included in the purchase list corresponding to the user information.

For example, when the category in which the no-show item is included is ‘food’, the proportion of items in the food category to all items that each of the promotion target candidates has bought using the application may be used as the purchase probability.

Here, the method of calculating the purchase probability is not limited to a certain algorithm, but any method using user information, such as the purchase behavior of a user, a list of purchases, and the like, may be used.

Also, in the method for selling a no-show item at a special price according to an embodiment of the present invention, the promotion information is provided to the promotion target group using the application, and the no-show item is sold at step S240.

Here, the promotion information may be provided using the terminals of the users included in the promotion target group. For example, the promotion information may be provided in the form of a message or a pop-up window using the application installed in the user terminal, or may be provided in the form of a text message or a notification message based on user information.

Here, when the no-show item has not been sold during a preset sales period from the time at which the promotion information was provided, the discount rate in the promotion information is changed, and the promotion information including the changed discount rate may be provided to the promotion target group.

For example, it may be assumed that the no-show item is sold at a 30% discount and that the preset sales period for the no-show item is 30 minutes. If the no-show item has not been sold within 30 minutes from provision of the promotion information, promotion information in which the discount rate for the item is changed to 40% may be created and provided again to the promotion target group.

Here, an upper limit to the discount rate may be set. When the no-show item is not sold even though promotion information in which the discount rate is set to the upper limit thereof has been provided, the sale of the item may be stopped, and a message announcing termination of the promotion may be provided to the promotion target group.

Here, when the no-show item has been sold, a message for announcing the completion of the sale may be provided to remaining users in the promotion target group, excluding the user who bought the corresponding item. That is, because the sale of the no-show item is made in real time, when payment for the corresponding item is made, the completion of the sale may be made known to the remaining users who received the promotion information.

Here, when payment for the no-show item has been made, it may be determined that the no-show item has been sold.

Here, payment for the no-show item may be made using a payment method included in the application or based on a payment flow using the application.

Also, although not illustrated in FIG. 2, in the method for selling a no-show item at a special price according to an embodiment of the present invention, various kinds of information generated in the above-described process of selling a no-show item at a special price may be stored in a separate storage module.

Through the above-described method for selling a no-show item at a special price, there may be provided a method for reducing the loss of a store incurred by no-shows, which has recently become a social problem.

Also, an opportunity to use a no-show item quickly and cheaply may be provided to users of an application.

Also, because a no-show item is presented to potential customers as a cheap and useful one, a promotional effect for the corresponding store may be generated.

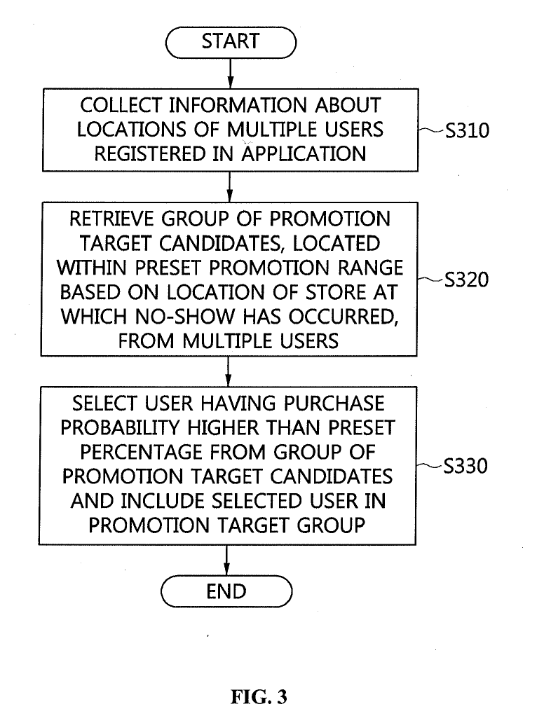

FIG. 3 is a flowchart that shows an example of the process of extracting a promotion target group in the method for selling a no-show item at a special price according to the present invention.

Referring to FIG. 3, in the process of extracting a promotion target group in the method for selling a no-show item at a special price according to the present invention, first, information about the locations of multiple users registered in an application may be collected at step S310.

Here, the information about the locations of the multiple users may be collected by acquiring user information from the server according to the present invention or a database operating in conjunction with the server. Here, the location of a user may be measured based on the user terminal carried by the user. For example, information about the location may be acquired using a GPS sensor included in the user terminal.

Then, a group of promotion target candidates, who are located within a preset promotion range based on the store at which a no-show has occurred, may be retrieved from the multiple users at step S320.

Here, the promotion range may be freely set and changed by at least one of the administrator of the server according to the present invention and the store at which the no-show has occurred. However, when the promotion range is set excessively wide, because the amount of data to be processed by the server in order to retrieve a group of promotion target candidates is increased, the promotion range may be set in consideration of the location of the store at which the no-show has occurred.

For example, if the store at which a no-show has occurred is located downtown with a large number of people moving around, many users may be retrieved as promotion target candidates even though the promotion range is set relatively narrow. Accordingly, the promotion range may be set to an area within a 1 km radius around the store at which the no-show has occurred.

In another example, if the store at which a no-show has occurred is located in a sparsely populated region with few people moving around, the promotion range is set relatively wide, whereby more than a certain number of users may be retrieved as the promotion target candidates. In this case, the promotion range may be set to an area within a 10 km radius around the store at which the no-show has occurred.

Here, when the number of promotion target candidates is less than a preset minimum number of candidates, the promotion target candidates may be retrieved again after the promotion range is extended.

For example, when the preset minimum number of candidates is 100 and when the number of promotion target candidates retrieved within a 1 km radius around the store at which a no-show has occurred is less than 100, the promotion target candidates may be retrieved again after the promotion range is extended to a 2 km radius around the store.

Also, when the number of promotion target candidates is less than the preset minimum number of candidates although the promotion target candidates are retrieved again, the preset promotion range may be extended further.

Then, a user having a purchase probability that is equal to or higher than a preset percentage may be selected from the promotion target candidates and included in a promotion target group at step S330.

For example, when the preset percentage for the purchase probability is 30%, a user having a purchase probability higher than 30% may be selected from the promotion target candidates and included in the promotion target group.

Here, it is necessary to provide promotion information to as many users as possible in order to maximize the likelihood of sale of the no-show item. Accordingly, the promotion target group may be configured so as to include more than a certain number of users. That is, when the promotion information is provided to 50 users, the possibility that the no-show item is sold is increased compared to when the promotion information is provided only to 10 users.

Therefore, when the number of users included in the promotion target group set depending on the purchase probability is less than a minimum reference number, the preset percentage for the purchase probability may be lowered, whereby the promotion target group may be extended.

Here, the purchase probability may be calculated in consideration of a list of purchases included in the category in which the no-show item is included in the purchase list corresponding to the user information.

For example, when the category in which the no-show item is included is ‘food’, the proportion of items in the food category to all items that each of the promotion target candidates has bought using the application may be used as the purchase probability.

Here, the method of calculating the purchase probability is not limited to a certain algorithm, but any method using user information, such as the purchase behavior of a user, a list of purchases, and the like, may be used.

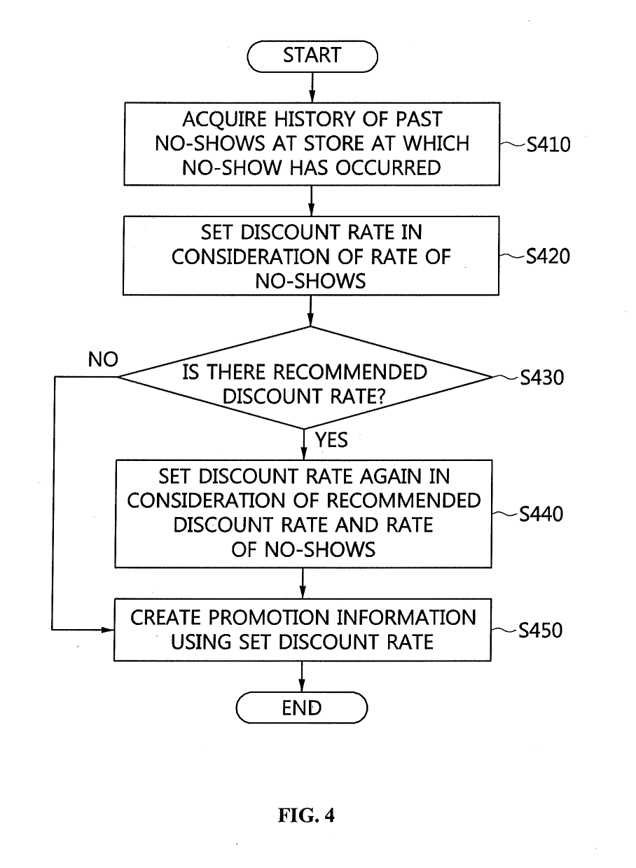

FIG. 4 is a flowchart that shows an example of the process of creating promotion information in the method for selling a no-show item at a special price according to the present invention.

Referring to FIG. 4, in the process of creating promotion information in the method for selling a no-show item at a special price according to the present invention, first, when a no-show has occurred in a certain store, a history of past no-shows at the corresponding store may be acquired using an application at step S410.

For example, using the identifier of the store at which the no-show has occurred, a history of past no-shows at the corresponding store may be acquired from the server corresponding to the application. That is, the server may store a history of past no-shows matched with the identifier of the store.

Then, a discount rate to be applied to the no-show item may be set at step S420 in consideration of the rate of no-shows at the store at which the no-show has occurred.

Here, the higher the rate of no-shows in each of the multiple stores, the higher the discount rate that may be applied to the no-show item.

For example, the number of times that a no-show has occurred at a certain store during a certain period may be monitored based on information about the occurrence of a no-show or information about a no-show item, which is input from each of the multiple stores, whereby the rate of no-shows may be calculated.

Here, a high rate of no-shows may mean that the sale of a no-show item at a special price is frequently made. That is, potential customers may be more likely to affordably use the item of the store having a high rate of no-shows. Accordingly, in terms of scarcity, the higher the rate of no-shows, the higher the discount rate to be applied to the no-show item may be set in order to increase sales competitiveness, whereby the sales rate of the item may be increased.

Then, it may be determined at step S430 whether there is a recommended discount rate for the no-show item, which is set by the store at which the no-show has occurred.

Here, the recommended discount rate may be a discount rate desired by the store at which the no-show has occurred. That is, in order to minimize the loss arising from the no-show at the store at which the no-show has occurred, it is necessary to sell the corresponding item at a price that is higher than the unit cost thereof. Therefore, when a no-show has occurred, the store at which the no-show has occurred may input a recommended discount rate along with the information about the no-show item so as to be delivered to the server for selling a no-show item at a special price.

When it is determined at step S430 that there is a recommended discount rate, the discount rate to be applied to the no-show item is set again at step S440 in consideration of the recommended discount rate and the rate of no-shows, and promotion information including the set discount rate may be created at step S450.

For example, when the recommended discount rate input by the store at which a no-show has occurred is 20% and when the discount rate calculated only in consideration of the rate of no-shows is 50%, promotion information in which a discount rate of about 35%, which is calculated as a compromise between the two discount rates, is applied to the no-show item may be created.

Also, when it is determined at step S430 that there is no recommended discount rate, promotion information may be created at step S450 using the discount rate set in consideration of the rate of no-shows, without the need to again set the discount rate.

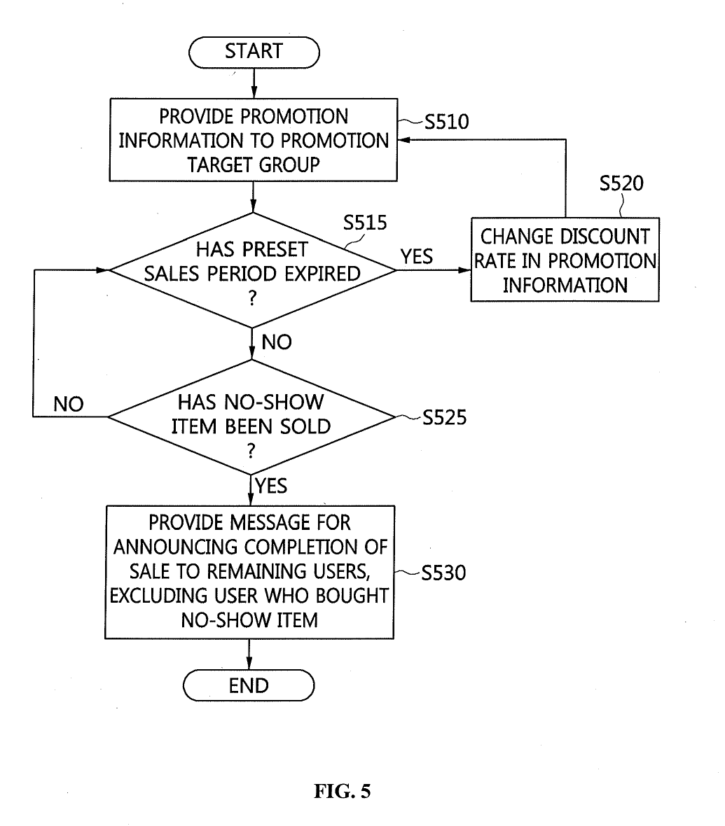

FIG. 5 is a flowchart that shows an example of the process of selling a no-show item in the method for selling a no-show item at a special price according to the present invention.

Referring to FIG. 5, in the process of selling a no-show item in the method for selling a no-show item at a special price according to the present invention, first, promotion information created so as to correspond to a no-show item is provided to a promotion target group at step S510.

For example, the promotion information may be provided in the form of a message or a pop-up window using an application installed in a user terminal, or may be provided in the form of a text message or a notification message based on user information.

Then, whether a preset sales period, which starts from the time at which the promotion information was provided, has expired is determined at step S515. When it is determined that the preset sales period has expired, the discount rate in the promotion information is changed at step S520, and the promotion information may be provided again at step S510.

For example, it may be assumed that a no-show item is sold at a 30% discount and that the preset sales period for the no-show item is 30 minutes. If the no-show item is not sold within 30 minutes from provision of the promotion information, promotion information in which the discount rate for the item is changed to 40% may be created and provided again to the promotion target group.

Also, when it is determined at step S515 that the preset sales period has not expired, whether the no-show item has been sold may be determined at step S525.

Here, when payment for the no-show item has been made, it is determined that the no-show item has been sold.

When it is determined at step S525 that the no-show item has not been sold, whether the preset sales period has expired may be determined again.

Also, when it is determined at step S525 that the no-show item has been sold, a message for announcing completion of the sale may be provided to remaining users, excluding the user who bought the corresponding item, at step S530.

That is, because the sale of the no-show item is made in real time, when payment for the corresponding item is made, the completion of the sale may be made known to the remaining users who received the promotion information.

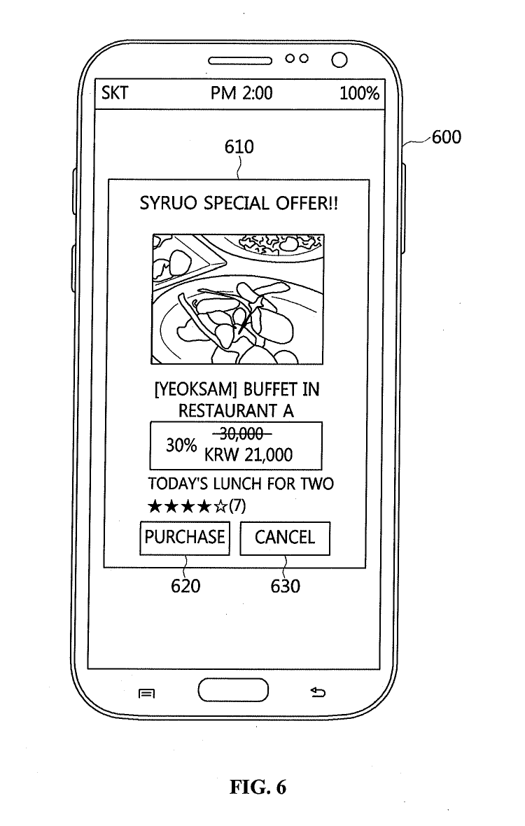

FIG. 6 is a view that shows an example of promotion information provided to a user according to the present invention.

Referring to FIG. 6, promotion information 610 provided to a user according to the present invention may be displayed in a user terminal 610.

Here, the promotion information 610 may be provided using a special application installed in the user terminal 600, or may be provided in the form of a text message or a pop-up window. Here, the promotion information may be provided along with vibration or sound such that a user is made aware of the reception of the promotion information quickly and easily, and the method of providing promotion information may not be limited to a specific method.

Here, the promotion information 610 may include information about a discounted price along with various kinds of information about the no-show item, as shown in FIG. 6.

Also, the promotion information 610 may include a purchase button 620 for buying the no-show item at a discounted price and a cancel button 630 for terminating the display of the promotion information 610.

When the user of the user terminal 600 selects the purchase button 620, an interface through which the user is capable of paying for the no-show item included in the promotion information 610 using the user's payment method registered in the application may be provided.

Also, after payment has been made, a message for announcing the completion of the sale of the no-show item may be provided to the store selling the corresponding item and other users included in the promotion target group.

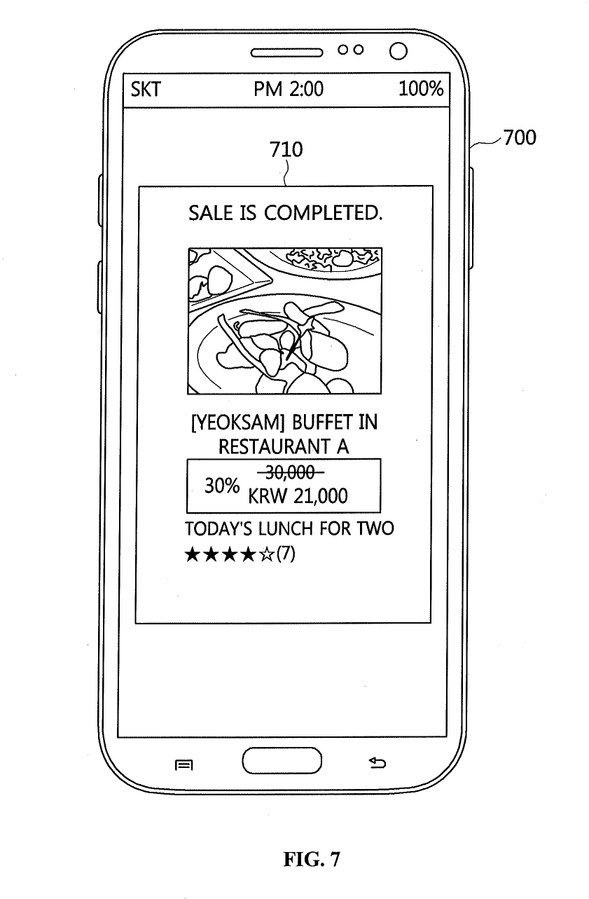

For example, a sale completion message 710 is provided to the user terminals 700 of other users included in the promotion target group, as shown in FIG. 7, whereby the completion of the sale of the no-show item may be made known to other users.

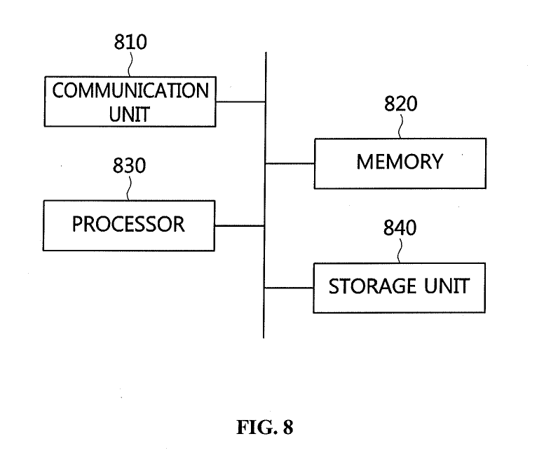

FIG. 8 is a block diagram that shows a server for selling a no-show item at a special price according to an embodiment of the present invention.

Referring to FIG. 8, the server for selling a no-show item at a special price according to an embodiment of the present invention includes a communication unit 810, memory 820, a processor 830, and a storage unit 840.

The communication unit 810 functions to send and receive information that is necessary in order to sell a no-show item at a special price to and from a user terminal over a communication network. Here, the communication unit 810 according to an embodiment of the present invention may deliver promotion information to a user terminal and receive payment information therefrom.

Also, the communication unit 810 according to an embodiment of the present invention may send and receive data related to information about whether a no-show has occurred, information about a no-show item, information about whether to buy a no-show item, and the like to and from a PC or a POS device installed in each store.

The memory 820 stores user information about multiple users registered in an application and information about a no-show item acquired from the store at which the no-show has occurred, among multiple stores registered in the application.

Here, the application may be a program running based on the server for selling a no-show item at a special price, and may be used when a user makes a reservation for a service or item of a store or buys a no-show item. For example, because multiple stores are registered in the application, a user may make a reservation or buy an item using his or her id registered therein. Here, the details about the reservation or the purchase may be stored as user information.

Here, the store at which a no-show has occurred means the store at which a user that has made a reservation does not show up. Depending on the business type of the store, various kinds of items may be made available due to a no-show. For example, if the store at which a no-show has occurred is a restaurant, a certain dish may be the no-show item. If the store at which a no-show has occurred is a nail art shop, a voucher for nail art or nail care may be the no-show item.

Here, a no-show item, which is to be sold by the store at which the no-show has occurred, may be an item that is difficult to sell after a certain period of time following occurrence of the no-show. For example, a dish that is difficult to serve to a customer when a certain time has passed or a service that can be provided only at the reserved time may be such a no-show item.

Therefore, when a no-show occurs at any of the multiple stores registered in the application, if a no-show item is determined to be difficult to sell after a certain period of time, information about the item is acquired and the process of selling the item at a special price is performed, but otherwise, the process of selling the item at a special price may not be performed.

Here, information about the no-show item may be received from a PC or a POS device installed in the store at which the no-show has occurred, and may then be stored in a separate database. For example, when a no-show occurs at restaurant A, a staff member or a manager in restaurant A inputs information about the no-show and information about the no-show item using a terminal or a PC in which the application for a store is installed, thereby providing the information to the server for selling a no-show item at a special price. The information about the no-show and the information about the no-show item, which are provided to the server, may be matched with each other, and may then be stored in the server or in a database that is separate from the server.

Here, the information about the no-show item may include various kinds of information that is necessary in order to sell the item, such as the name of the item, the time at which the item can be used, the price of the item, the store that is selling the item, the location of the store, and the like.

The processor 830 creates promotion information for selling a no-show item using information about the no-show item, provides the promotion information to a promotion target group, extracted from the multiple users in consideration of at least one of the location of the store at which the no-show has occurred, the information about the no-show item, and user information, and sells the no-show item.

First, promotion information for selling the no-show item at a special price may be created using the information about the no-show item.

Here, the promotion information may be an advertising message to be provided to potential customers in order to sell the no-show item. Therefore, the promotion information may include information about the corresponding item to be sold at a special price, the price thereof, the location of the store at which the item can be used, and the like.

Also, if the promotion information is information for advertising the no-show item, the promotion information may include a media file, such as various images, video, and the like, along with the above-mentioned information, or may be created using comments or a design desired by the store selling the no-show item.

Here, the higher the rate of no-shows in each of the multiple stores, the higher the discount rate that may be applied to the no-show item.

For example, the number of times that a no-show has occurred at a certain store during a certain period may be monitored based on information about the occurrence of a no-show, information about a no-show item, and the like, which are input from each of the multiple stores, whereby the rate of no-shows may be calculated.

Here, a high rate of no-shows may mean that the sale of a no-show item at a special price is frequently made. That is, potential customers may be more likely to affordably use the item of the store having a high rate of no-shows. Accordingly, in terms of scarcity, the higher the rate of no-shows, the higher the discount rate to be applied to the no-show item may be set in order to increase sales competitiveness, whereby the sales rate of the item may be increased.

Here, when there is a recommended discount rate set by the store at which the no-show has occurred, the discount rate may be set in consideration of the recommended discount rate and the rate of no-shows. That is, in order to minimize the loss arising from the no-show at the store at which the no-show has occurred, it is necessary to sell the corresponding item at a price that is higher than the unit cost thereof. Therefore, when a no-show has occurred, the store at which the no-show has occurred may input a recommended discount rate along with the information about the no-show item so as to be delivered to the server for selling a no-show item at a special price.

For example, when the recommended discount rate input by the store at which a no-show has occurred is 20% and when the discount rate calculated only in consideration of the rate of no-shows is 50%, a discount rate of about 35%, which is calculated as a compromise between the two discount rates, may be applied to the no-show item.

Here, the promotion information created for the no-show item may be stored in a separate database after being matched with at least one of the store at which the no-show has occurred and the information about the no-show item.

Then, a promotion target group to which the promotion information is to be provided may be extracted in consideration of at least one of the location of the store at which the no-show has occurred, the information about the no-show item, and user information.

Here, the user information may be acquired based on the server according to the present invention or the database operating in conjunction with the server. Here, the user information may be information about each of the multiple users registered in the application.

Here, the promotion target group may be a group of users who will receive the promotion information. That is, the promotion target group may be extracted from the multiple users in consideration of at least one of the location of the store at which the no-show has occurred, the information about the no-show item, and the user information.

Here, a group of promotion target candidates who are located within a preset promotion range based on the location of the store at which the no-show has occurred may be retrieved from the multiple users registered in the application. That is, among the multiple users, users who are located within the preset promotion range may be set as a group of promotion target candidates.

Here, information about the locations of the multiple users may be acquired based on the user terminals of the multiple users. For example, the locations of the multiple users may be acquired using a GPS sensor included in each of the user terminals.

Here, the promotion range may be freely set and changed by at least one of the administrator of the server according to an embodiment of the present invention and the store at which the no-show has occurred. However, when the promotion range is set excessively wide, because the amount of data to be processed by the server in order to retrieve a group of promotion target candidates is increased, the promotion range may be set in consideration of the location of the store at which the no-show has occurred.

For example, if the store at which a no-show has occurred is located downtown with a large number of people moving around, many users may be retrieved as promotion target candidates even though the promotion range is set relatively narrow. Accordingly, the promotion range may be set to an area within a 1 km radius around the store at which the no-show has occurred.

In another example, if the store at which a no-show has occurred is located in a sparsely populated region with few people moving around, the promotion range is set relatively wide, whereby more than a certain number of users may be retrieved as the promotion target candidates. In this case, the promotion range may be set to an area within a 10 km radius around the store at which the no-show has occurred.

Here, when the number of promotion target candidates is less than a preset minimum number of candidates, the promotion target candidates may be retrieved again after the promotion range is extended.

For example, when the preset minimum number of candidates is 100 and when the number of promotion target candidates retrieved within a 1 km radius around the store at which the no-show has occurred is less than 100, the promotion target candidates may be retrieved again after the promotion range is extended to a 2 km radius around the store.

Also, when the number of promotion target candidates is less than the preset minimum number of candidates even after repeated retrieval of the promotion target candidates, the preset promotion range may be extended further.

Here, a user having a purchase probability that is equal to or higher than a preset percentage may be selected from the promotion target candidates and included in the promotion target group, the purchase probability being calculated based on the user information and the information about the no-show item.

For example, when the preset percentage for the purchase probability is 30%, a user having a purchase probability higher than 30% may be selected from the promotion target candidates and included in the promotion target group.

Here, it is necessary to provide the promotion information to as many users as possible in order to maximize the likelihood of sale of the no-show item. Accordingly, the promotion target group may be configured so as to include more than a certain number of users. That is, when the promotion information is provided to 50 users, the possibility that the no-show item is sold is increased compared to when the promotion information is provided only to 10 users.

Therefore, when the number of users included in the promotion target group set depending on the purchase probability is less than a minimum reference number, the preset percentage for the purchase probability may be lowered, the number of users included in the promotion target group may be increased.

Here, the purchase probability may be calculated in consideration of a list of purchases included in the category in which the no-show item is included in the purchase list corresponding to the user information.

For example, when the category in which the no-show item is included is ‘food’, the proportion of items in the food category to all items that each of the promotion target candidates has bought using the application may be used as the purchase probability.

Here, the method of calculating the purchase probability is not limited to a certain algorithm, but any method using user information, such as the purchase behavior of a user, a list of purchases, and the like, may be used.

Then, promotion information is provided to the promotion target group using the application, and the no-show item may be sold.

Here, the promotion information may be provided using the terminals of the users included in the promotion target group. For example, the promotion information may be provided in the form of a message or a pop-up window using the application installed in the user terminal, or may be provided in the form of a text message or a notification message based on user information.

Here, when the no-show item is not sold within a preset sales period from the time at which the promotion information was provided, the discount rate in the promotion information is changed, and the promotion information including the changed discount rate may be provided to the promotion target group.

For example, it may be assumed that the no-show item is sold at a 30% discount and that the preset sales period for the no-show item is 30 minutes. If the no-show item is not sold within 30 minutes from provision of the promotion information, promotion information in which the discount rate for the item is changed to 40% may be created and provided again to the promotion target group.

Here, an upper limit to the discount rate may be set. When the no-show item has not been sold even though promotion information in which the discount rate is set to the upper limit thereof was provided, the sale of the item may be stopped, and a message announcing termination of the promotion may be provided to the promotion target group.

Here, when the no-show item has been sold, a message for announcing the completion of the sale may be provided to remaining users in the promotion target group, excluding the user who bought the corresponding item. That is, because the sale of the no-show item is made in real time, when payment for the corresponding item is made, the completion of the sale may be made known to the remaining users who received the promotion information.

Here, when payment for the no-show item is made, it may be determined that the no-show item has been sold.

Here, payment for the no-show item may be made using a payment method included in the application or based on a payment flow using the application.

The storage unit 840 may support a function for selling a no-show item at a special price according to an embodiment of the present invention, as described above. Here, the storage unit 840 may operate as separate mass storage, and may include control functions for performing operations.

Meanwhile, the server may store information in memory installed therein. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard disk device, an optical disk device, or any other kind of mass storage.

Using the above-described server, there may be provided a method for reducing the loss of a store incurred by no-shows, which has recently become a social problem.

Also, an opportunity to use a no-show item quickly and cheaply may be provided to users of an application.

Also, because a no-show item is presented to potential customers as a cheap and useful one, a promotional effect for the corresponding store may be generated.

The functional operations and implementations of the subject matter described herein may be implemented as digital electronic circuitry, or may be implemented in computer software, firmware, or hardware, including the structures disclosed herein and structural equivalents thereof, or one or more combinations thereof. Implementations of the subject matter described herein may be implemented in one or more computer program items, in other words, one or more modules of computer program instructions encoded on a tangible program storage medium in order to control the operation of a processing system or to be executed by the processing system.

The computer-readable medium may be a machine-readable storage device, a machine-readable storage substrate, a memory device, a composition of material that affects a machine-readable radio-wave-type signal or one or more combinations thereof.

As used herein, the terms ‘system’ or ‘device’ include all kinds of apparatuses, devices and machines for processing data, which include, for example, a programmable processor and a computer, or multiple processors and a computer. In addition to hardware, the processing system may also include, for example, code that configures processor firmware, and code that configures an execution environment for computer programs in response to a request from a protocol stack, a database management system, an operating system, or one or more combinations thereof.

A computer program (also known as a program, software, a software application, a script or code) may be written in any form of programming language including a compiled or interpreted language, or an a priori or procedural language, and may be deployed in any form including standalone programs or modules, components, subroutines, or other units suitable for use in a computer environment. The computer program does not necessarily correspond to a file in a file system. The program may be stored in a single file provided to the requested program, in multiple interactive files (for example, files storing one or more modules, subprograms or portions of code), or in a part of a file containing other programs or data (for example, one or more scripts stored in a markup language document). The computer program may be located on a single site or distributed across multiple sites such that it is deployed to run on multiple computers interconnected by a communications network or on a single computer.

The computer-readable medium suitable for storing computer program instructions and data may include, for example, semiconductor memory devices, such as EPROM, EEPROM and flash memory devices, all types of nonvolatile memory, including magnetic disks, such as internal hard disks or external disks, magnetic optical disks, CD-ROMs and DVD-ROMs, media, and memory devices. A processor and memory may be supplemented by special-purpose logic circuits, or may be integrated therewith.

Implementations of the subject matter described herein may be realized on an arithmetic system including, for example, a back-end component such as a data server, a middleware component such as an application server, a front-end component such as a client computer with a web browser or a graphical user interface through which a user may interact with the implementations of the subject matter described herein, or one or more combinations of the back-end component, the middleware component, and the front-end component. The components of the system may be interconnected using any form or medium of digital data communication such as a communication network.

While the present invention includes a number of specific implementation details, they should not be construed as limitations on the scope of the invention or the claimable scope, but should be understood as a description of features that may be specific to particular embodiments of the invention. Similarly, the specific features described herein in the context of individual embodiments may be implemented by being combined in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may be excluded from the combination in some cases, and the claimed combination may be altered to a sub-combination or variation thereof.

Also, while this specification illustrates operations in the drawings in a particular order, it should not be understood that such operations must be performed in the particular order or the sequential order shown in the drawings in order to obtain a desired result, or that all of the illustrated operations should be performed. In certain cases, multitasking and parallel processing may be advantageous. Also, separation of the various system components of the above-described embodiment should not be understood as requiring such separation in all embodiments, and it should be understood that the program components and systems described above may generally be integrated into a single software item or packaged into multiple software items.

According to the present invention, information about a no-show item is acquired from the store at which the no-show has occurred, among multiple stores registered in an application, promotion information for selling the no-show item at a special price is created using the information about the no-show item, a promotion target group to which the promotion information is to be provided is extracted in consideration of at least one of the location of the store at which the no-show has occurred, the information about the no-show item, and user information, and the promotion information is provided to the promotion target group using the application, whereby the no-show item may be sold. Also, according to the present invention, the economic loss of the store incurred by no-shows may be reduced, and the opportunity to be quickly provided with a service at a low price may be provided to multiple users.

According to the present invention, there may be provided a method for reducing the loss of a store incurred by no-shows, which has recently become a social problem.

Also, the present invention may provide users of an application with the opportunity to use a no-show item quickly and cheaply.

Also, the present invention may make a no-show item appear to potential customers as a cheap and useful one, whereby a promotional effect for the corresponding store may be generated.

This specification is not intended to limit the present invention to the specific terms disclosed herein. Therefore, although the present invention has been described in detail with reference to the above examples, those skilled in the art may conceive alternations, modifications, and variations on these examples without departing from the scope of the present invention. The scope of the present invention is defined by the appended claims rather than the description, and it should be construed that all alternations and modifications derived from the meaning and scope of the appended claims and their equivalents are included within the scope of the present invention.

What is claimed is:

1. A method for selling a no-show item at a special price, comprising:
acquiring information about a no-show item from a store at which the no-show has occurred, among multiple stores registered in an application;
creating promotion information for selling the no-show item at a special price using the information about the no-show item;
extracting a promotion target group to which the promotion information is to be provided in consideration of at least one of a location of the store at which the no-show has occurred, the information about the no-show item, and user information; and
selling the no-show item by providing the promotion target group with the promotion information based on the application.

2. The method of claim 1, wherein extracting the promotion target group comprises:
retrieving a group of promotion target candidates, who are located within a preset promotion range based on the location of the store at which the no-show has occurred, from multiple users registered in the application; and
selecting a user having a purchase probability that is equal to or higher than a preset percentage from the group of the promotion target candidates and including the selected user in the promotion target group, the purchase probability being calculated based on the user information and the information about the no-show item.

3. The method of claim 2, wherein the purchase probability is calculated in consideration of a list of purchased items included in a category of the information about the no-show item in a list of purchases corresponding to the user information.

4. The method of claim 1, wherein creating the promotion information is configured to set a discount rate to be applied to the no-show item higher as a rate of no-shows in each of the multiple stores is higher.

5. The method of claim 4, wherein creating the promotion information is configured to set the discount rate in consideration of a recommended discount rate and the rate of no-shows when the recommended discount rate set by the store at which the no-show has occurred is present.

6. The method of claim 4, wherein selling the no-show item comprises:
when the no-show item has not been sold for a preset sales period from a time at which the promotion information was provided, changing the discount rate in the promotion information and providing the promotion information including the changed discount rate to the promotion target group.

7. The method of claim 2, wherein retrieving the group of the promotion target candidates comprises:
when a number of promotion target candidates is less than a preset minimum number of candidates, extending the preset promotion range and retrieving the group of the promotion target candidates again.

8. The method of claim 1, wherein selling the no-show item is configured to provide a sale completion message to remaining users in the promotion target group, excluding a user who bought the no-show item, when the no-show item has been sold.

9. A server, comprising:
memory for storing user information about multiple users registered in an application and information about a no-show item acquired from a store at which the no-show has occurred, among multiple stores registered in the application; and
a processor for creating promotion information for selling the no-show item at a special price using the information about the no-show item, providing the promotion information to a promotion target group, which is extracted from the multiple users in consideration of at least one of a location of the store at which the no-show has occurred, the information about the no-show item, and the user information, and thereby selling the no-show item.

10. The server of claim 9, wherein the processor is configured to:
retrieve a group of promotion target candidates who are located within a preset promotion range based on the location of the store at which the no-show has occurred from the multiple users; and
select a user having a purchase probability that is equal to or higher than a preset percentage from the group of the promotion target candidates and include the selected user in the promotion target group, the purchase probability being calculated based on the user information and the information about the no-show item.
